(19) United States
(12) Patent Application Publication
(10) Pub. No.: US 2019/0329160 A1
(43) Pub. Date: Oct. 31, 2019

(54) Filter Medium Having a Sealing Portion

(71) Applicants: Frederick Halliday, Bad Soden Salmunster (DE); Ivan Rosi, Alicante (ES)

(72) Inventors: Frederick Halliday, Bad Soden Salmunster (DE); Ivan Rosi, Alicante (ES)

(21) Appl. No.: 16/385,770

(22) Filed: Apr. 16, 2019

Related U.S. Application Data
(60) Provisional application No. 62/663,004, filed on Apr. 26, 2018.
(60) Provisional application No. 62/760,637, filed on Nov. 13, 2018.

(51) Int. Cl. B01D 29/05; B01D 39/14

(52) U.S. Cl. CPC B01D 29/05; B01D 39/14; B01D 2239/0464; B01D 2239/0407; B01D 2201/34

(57) ABSTRACT

A filter medium which includes a filter portion, such as a filter pad, and a sealing portion that extends outwardly from the filter portion, and is capable of acting as a gasket and forming a seal with the bottom panel of a container in which the filter medium is placed. The filter medium may be used to filter and purify a variety of fluids, including used cooking oil, unrefined edible oils, beer, wine, and biodiesel fuel. The filter medium provides for improved filtration and purification of fluids, and is resistant to breakage.

This application claims priority based on provisional Application Ser. Nos. 62/663,004, filed Apr. 26, 2018 and 62/760,637, filed Nov. 13, 2018, the contents of which are incorporated by reference in their entireties.

This invention relates to filter media which are used to filter impurities from fluids, such as, for example, used cooking oils, unrefined edible oils, fruit-based and vegetable-based beverages, such as beer and wine, and biodiesel fuel. More particularly, this invention relates to a filter medium which has a filter portion and a sealing portion. The sealing portion is capable of forming a seal with the bottom panel of a container through which the fluid passes.

A variety of fluids, such as, for example, unrefined edible oils, fruit-based or vegetable-based beverages such as beer and wine, and biodiesel fuel, are filtered to remove impurities from the fluid during the refining or manufacturing process. Other fluids, such as, for example, used cooking oils, are filtered to remove impurities therefrom such that the fluid may be reused.

In a typical filtering operation, the fluid to be purified is passed into a container, such as a pan or vat, that has a bottom panel and at least one wall extending upwardly from the bottom panel. The bottom panel has a conduit extending therefrom, through which the fluid passes after it passes through the filter. In addition, the bottom panel may include at its periphery, near the wall(s) of the pan or vat, a raised portion, which may be in the form of an inverted “V” which acts as a dike.

In general, a spacer grid, which may be formed from perforated metal, expanded metal, or wire cloth containing a plurality of openings through which the fluid may pass, is placed on top of the bottom panel of the vat or pan, and, if a “dike” or raised portion is present, is placed inside the “dike” or raised portion on the floor of the vat or pan.

Placed on top of the spacer grid is a filter medium. The filter medium may be in the form of a filter pad, which may be formed from materials such as cellulosic fibers and resin binders. The filter pad has permeability which is sufficient for allowing the passage of the liquid therethrough. The filter medium in general extends over the raised portion, or “dike” of the bottom panel, if a “dike” or raised portion is present, and often abuts against the wall(s) of the pan or vat. The filter pad may be impregnated with an adsorbent material which may be in the form of a powder, such as a silica-containing material such as, for example, magnesium silicate. Alternatively, the adsorbent powder may be placed on top of the filter pad.

Once the filter pad is placed on the spacer grid, a weight ring is placed on the filter pad in order to hold the filter pad in place. In general, when the weight ring is placed on the filter pad, the weight ring is disposed between the raised portion or dike, if present, of the bottom panel of the pan or vat, and the wall(s) of the pan or vat.

Once the spacer grid, filter medium, such as a filter pan, and weight ring are placed in the filter pan or vat, the liquid which is to be purified is placed into the filter pan or vat. In general, there is a conduit in communication with the bottom panel of the filter pan or vat, and the conduit is connected to a vacuum apparatus. Once a vacuum is applied, the liquid is drawn through the filter medium, such as a filter pad, and any adsorbent which may have been placed on or into the filter pad, thereby purifying the liquid. The liquid then passes through the spacer grid, and then into the conduit, after which the purified liquid is collected for future consumption, as is the case with edible oils, beverages, or biodiesel, for example, or is recycled, as is the case with used cooking oil.

During the filtering of the liquid, the filter medium, such as a filter pad, often is subject to breakage, thus rendering the filter medium unusable for further filtering. Such breakage may be a result of various factors, such as, for example, the weight of the weight ring which presses upon the filter pad, or the formation of an improper seal between the filter pad and the bottom panel of the filter pan or vat.

It therefore is an object of the present invention to provide a filter medium that provides for acceptable filtration and purification of a fluid, while being able to withstand the rigors of a plurality of purifications and filtrations.

In accordance with an aspect of the present invention, there is provided a filter medium for removing impurities from a fluid as a liquid passes through a container. The container comprises a bottom panel and at least one wall extending upwardly from the bottom panel. The filter medium comprises a filter portion and a sealing portion. The filter portion is capable of removing impurities from the fluid. The sealing portion extends outwardly from the filter portion and is affixed to the filter portion. The sealing portion is capable of forming a seal with the bottom panel when the filter medium is placed in the container.

In a non-limiting embodiment, the filter portion has a first permeability and the sealing portion has a second permeability. The first permeability is greater than the second permeability. In another non-limiting embodiment, the sealing portion is impermeable.

In another non-limiting embodiment, the permeabilities of the filter portion and the sealing portion are identical.

In another non-limiting embodiment, the filter portion has a first permeability and the second portion has a second permeability. The second permeability is greater than the first permeability.

In a non-limiting embodiment, the filter portion is impregnated with at least one adsorbent material.

In another non-limiting embodiment, the at least one adsorbent material is selected from the group consisting of magnesium silicate, magnesium aluminum silicate, calcium silicate, sodium silicates, activated carbon, silica gel, magnesium phosphate, metal hydroxides, metal oxides, metal carbonates, metal bicarbonates, sodium sesquicarbonate, metal silicates, bleaching clays, bleaching earths, bentonite clay, alumina, diatomaceous earth, perlite, and combinations thereof. In yet another non-limiting embodiment, the at least one adsorbent material is magnesium silicate.

Magnesium silicate is a compound containing magnesium oxide (MgO) and silicon dioxide (SiO₂) and may be hydrated. Magnesium silicate may have the formula MgOxSiO₂.mH₂O, wherein x is the molar ratio of SiO₂ to MgO, and m is the number of moles of chemically bound water.

Synthetic magnesium silicate is manufactured by effecting a precipitation reaction between a soluble magnesium salt, such as, for example, magnesium sulfate (MgSO₄), magnesium chloride (MgCl₂), or magnesium nitrate (Mg(NO₃)₂), and a metal silicate, such as, for example, sodium silicate.

In general, the magnesium salt and the metal silicate are reacted in an aqueous solution to produce a slurry of magnesium silicate, which may be a hydrated magnesium silicate, suspended in an aqueous solution. The slurry then is filtered, and the collected magnesium silicate is washed, dried, and classified for particle size. Examples of such synthetic magnesium silicates which may be employed are described in U.S. Pat. Nos. 4,681,768; 5,006,356; 5,597,600; 6,312,598; 6,482,326; 7,635,398; and 9,295,810.

Alternatively, the at least one adsorbent material is placed on top of the filter portion prior to the filtration and purification of the fluid.

The filter portion may be in any of a variety of shapes, including, but not limited to, circular, i.e., in the form of a disc, or polygonal. In a non-limiting embodiment, the filter portion is in the form of a quadrilateral, including, but not limited to, rectangular and square shapes.

The sealing portion extends outwardly from the peripheral edge or edges of the filter portion, and has a width that is sufficient for the sealing portion to form a seal with the bottom panel of the container when the filter medium is placed in the container.

In a non-limiting embodiment, the sealing portion is in the form of a panel which has a shape (eg., circular or polygonal) that is the same as that of the filter portion and has an area greater than that of the filter portion. In such an embodiment, the filter portion is affixed to the sealing portion such that the entire bottom surface of the filter portion is in contact with the sealing portion, and a portion of the sealing portion extends outwardly from the peripheral edge or edges of the filter portion.

In a non-limiting embodiment, when the entire bottom surface of the filter portion is in contact with the sealing portion, the permeabilities of the filter portion and the sealing portion are identical.

In another non-limiting embodiment, the sealing portion has the same shape as the filter portion, but is in the form of a “frame”, i.e., the sealing portion is in contact with the filter portion only at the peripheral edge or edges of the filter portion.

In a non-limiting embodiment, when the sealing portion is in the form of a “frame”, the permeability of the filter portion is greater than that of the sealing portion, and, in some embodiments, the sealing portion is impermeable.

The sealing portion may be affixed to the filter portion by a variety of means, such as by stitching or by an adhesive.

In a non-limiting embodiment, the sealing portion is affixed to the filter portion by stitching. Such stitching may be accomplished by any of a variety of methods known to those skilled in the art, and may employ any of a variety of acceptable threads or sutures. When the sealing portion is affixed to the filter portion by stitching, at least one thread or suture is employed. When more than one thread or suture is employed, such threads or sutures may affix the sealing portion to the filter portion by stitching arrangements in a variety of patterns. For example, the threads or sutures may by parallel to each other, or may intersect in a variety of patterns. The number of threads or sutures, and the arrangement of the threads or sutures is dependent upon a variety of factors, including, but not limited to, the size of the filter medium, the shape of the filter medium, and the materials from which the filter portion and the sealing portion are formed.

In another non-limiting embodiment, the sealing portion is affixed to the filter portion by an adhesive, such as, for example, any of a variety of “hot melt” glues.

The filter portion may be formed from any materials which are acceptable for filtering and purifying liquids. In a non-limiting embodiment, the filter portion is formed from materials including cellulosic fiber and resin binder. Cellulosic fibers which may be employed include, but are not limited to, those obtained from wood pulp. Examples of such wood pulp fibers which may be employed include those sold under the trade name “Regular Kraft” by Weyerhaueser Company of Federal Way, Wash., and those sold under the trade name “Tyee Kraft”, also by Weyerhaueser Company. Resin binders which may be employed include, but are not limited to, melamime-formaldehyde resins, urea-formaldehyde resins, or any number of “food grade” commercially available resins, such as, for example, modified food starch, adipic acid/epoxypropyl diethylenetriamine copolymer, and sodium carboxymethyl cellulose.

In another non-limiting embodiment, the filter portion may be formed from a combination of cellulosic fibers and one or more passive adsorbents, such as perlite or diatomaceous earth.

In a non-limiting embodiment, the sealing portion, like the filter portion, also may be formed from materials including the cellulosic fibers and resin binders hereinabove described, or a combination of the cellulosic fibers and passive adsorbents hereinabove described.

The filter medium may be used in combination with any acceptable container, such as a pan or vat, that is used in connection with the filtration or purification of a fluid. The container has a shape which is in conformity with that of the filter medium. In one non-limiting embodiment, the container has a bottom panel, which has a conduit, such as a pipe, extending downwardly therefrom, and may have a raised portion at its periphery which acts as a “dike”. A spacer grid may be placed on top of the bottom panel. In general, the spacer grid is placed inside the “dike”, when a “dike” is present.

The filter medium is placed on top of the spacer grid. In a non-limiting embodiment, the filter medium is configured such that the filter portion, like the spacer grid, is inside the “dike”, and the sealing portion extends outwardly from the filter portion and over the “dike”, and may abut against the wall(s) of the filter pan or vat. A weight ring then is placed on top of the filter medium such that the weight ring presses against the sealing portion of the filter medium, such that the sealing portion is held against the bottom panel of the filter pan or vat.

Once the filter medium is secured in the filter pan or vat, the liquid that is to be filtered or purified is placed in the filter pan or vat. In general, the conduit or pipe that extends from the bottom panel of the pan or vat is connected to a vacuum, whereby the vacuum aids in drawing the liquid downwardly through the filter portion, such as a filter pad, of the filter medium, the spacer grid, and through the conduit or pipe. As the vacuum is applied, the sealing portion forms a tight seal against the bottom panel of the pan or vat. The seal is formed by a combination of the application of the vacuum, and the pressing of the weight ring against the sealing portion of the filter medium. Thus, the sealing medium acts as a “sealing gasket”, which provides for more efficient filtering and purification of the fluid. Also, because the filter portion is not in contact with the weight ring, the likelihood of breakage of the filter medium is reduced.

### BRIEF DESCRIPTION OF THE DRAWINGS

The invention now will be described with respect to the drawings, wherein:

FIG. 1 is an exploded view of a non-limiting embodiment of the filter medium of the present invention, in combination with a weight ring, a spacer grid, and a filter vat;

FIG. 2 is a top view of the filter medium contained in the filter vat;

FIG. 3 is a cut away side view of the filter medium contained within the filter vat;

FIG. 4 depicts four alternative non-limiting embodiments of the filter medium of the present invention, wherein each embodiment depicts different stitching attachments of the sealing portion to the filter portion;

FIG. 5 is an exploded view of another non-limiting embodiment of the filter medium of the present invention in which the sealing portion consists of four sealing strips which are in contact with only the peripheral edges of the filter portion; and

FIG. 6 depicts the attachment of the four sealing strips of the sealing portion of the filter medium to the peripheral edges of the filter portion of the filter medium shown in FIG. 5 by stitching;

FIG. 7 is an exploded view of another non-limiting embodiment of the filter medium of the present invention in which the sealing portion consists of two complementary L-shaped sealing means which are in contact with only the peripheral edges of the filter portion; and

FIG. 8 depicts the attachment of the two L-shaped sealing means of the sealing portion of the filter medium to the peripheral edges of the filter portion of the filter medium shown in FIG. 7 by stitching.

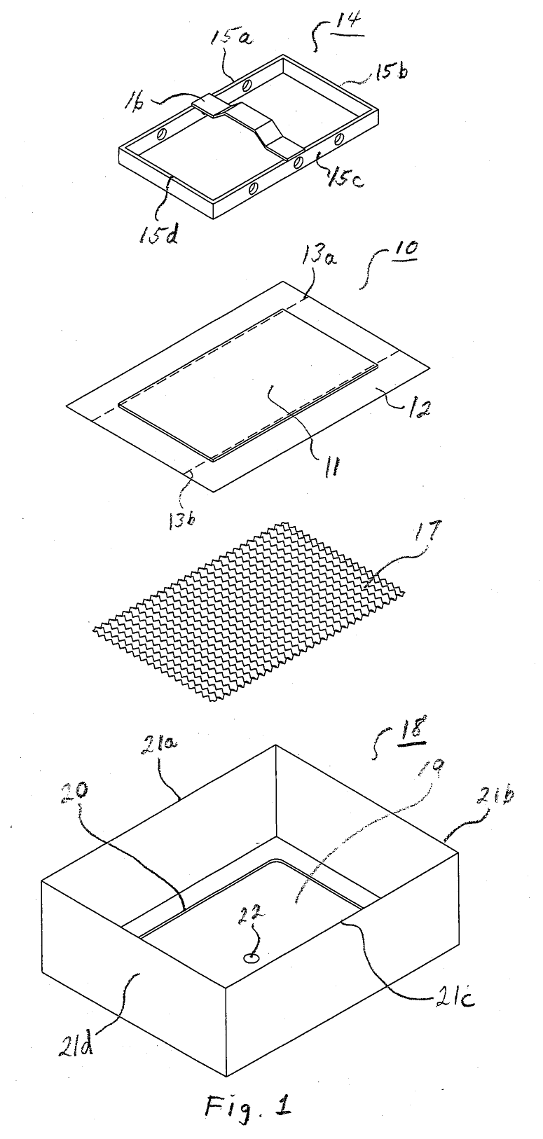

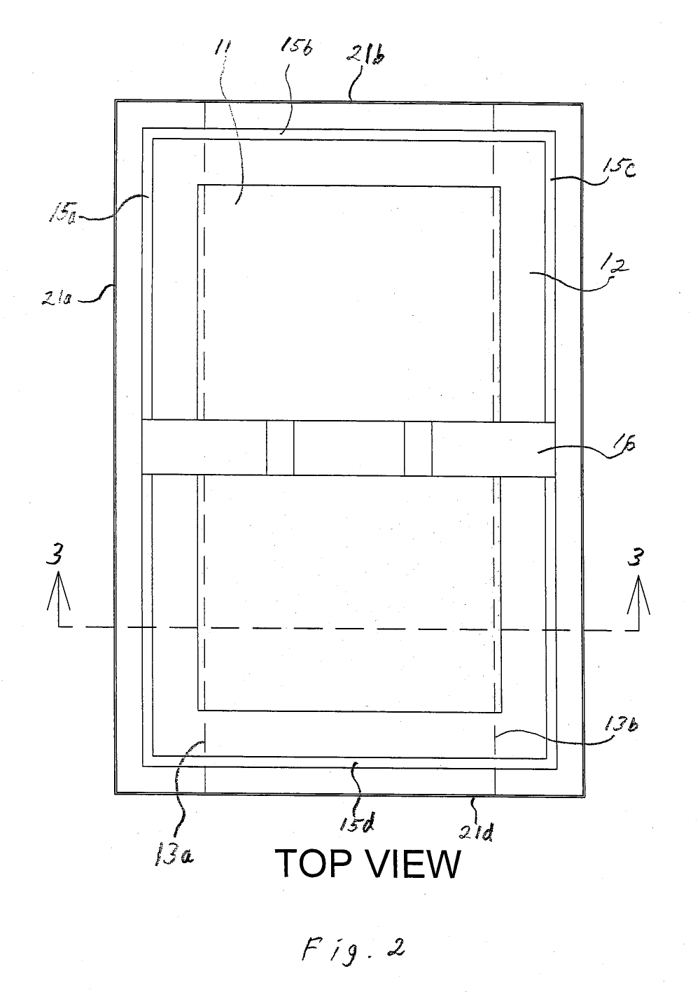

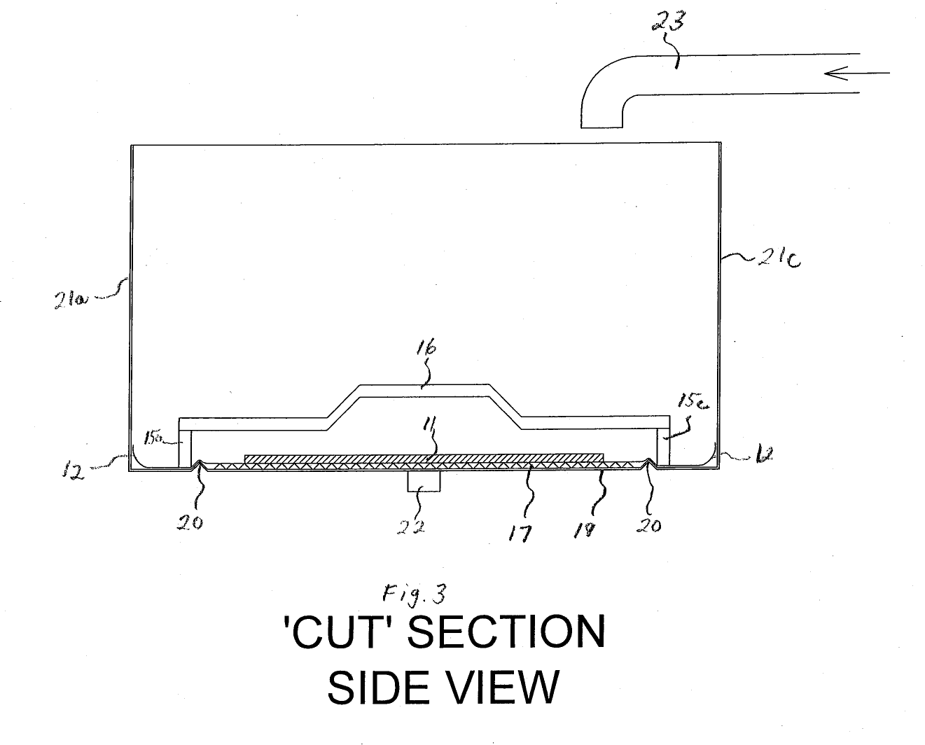

Referring now to the drawings, as shown in FIGS. 1 through 3, a filter medium 10 includes a filter portion 11, which may be in the form of a filter pad, and a sealing portion 12. The entire bottom surface of filter pad 11 is in contact with sealing portion 12, and sealing portion 12 is attached or affixed to filter pad 11 by stitches 13a and 13b. Sealing portion 12 has a greater cross-sectional area then filter pad 11, and thus has a portion that extends outwardly from filter pad 11.

Filter pad 11 and sealing portion 12 may be formed from the same or similar materials, such as cellulosic fibers and resin binders or a combination of cellulosic fibers and a passive adsorbent, such as diatomaceous earth or perlite.

Filter medium 10 and spacer grid 17 are placed within a filter vat 18. Filter vat 18 includes a bottom panel 19, a raised portion or “dike” 20 at its periphery, and walls 21a, 21b, 21c, and 21d. A conduit or pipe 22 extends downwardly from bottom panel 19. Conduit 22 may be connected to a vacuum (not shown).

Spacer grid 17 is placed upon bottom panel 19 of vat 18, and is contained within dike 20. Filter medium 10 then is placed upon spacer grid 17. Filter medium 10 is configured such that the filter pad 11, like spacer grid 17, is contained inside dike 20, while the sealing portion 12 extends over dike 20 and abuts against walls 21a, 21b, 21c, and 21d of vat 18.

After spacer grid 17 and filter medium 10 have been placed within vat 18, weight ring 14 is placed within vat 18. Weight ring 14 has side portions 15a, 15b, 15c, and 15d, and a handle 16. Weight ring 14 is placed in vat 18 such that sides 15a, 15b, 15c, and 15d of weight ring 14 contact sealing portion 12 of filter medium 10, and press sealing portion 12 against bottom panel 19 of vat 18. Sides 15a, 15b, 15c, and 15d are disposed between dike 20 and sides 21a, 21b, 21c, and 21d. The weight of sides 15a, 15b, 15c, and 15d upon sealing portion 12 aid in providing a tight seal of sealing portion 12 against bottom panel 19 of vat 18.

The filter medium of the present invention may be used to filter a variety of fluids, including used cooking oil, edible oils, fruit-based and vegetable-based beverages, such as beer and wine, and biodiesel fuel. FIGS. 1 through 3 depict the filter medium 10 contained within a vat 18 which may be used to filter used cooking oil, although fluids such as those hereinabove described could be filtered as well. In a non-limiting embodiment, used cooking oil from a fryer (not shown) is passed through pipe 23 into vat 18. A vacuum apparatus (not shown) is connected to pipe 22, and a vacuum is applied to pipe 22 and vat 18 to aid in drawing the used cooking oil through vat 18. The used cooking oil contacts filter pad 11, which may be impregnated with an adsorbent powder, such as magnesium silicate that removes impurities which include free fatty acids from the used cooking oil as the oil passes through filter pad 11. Alternatively, the adsorbent powder may be placed on top of filter pad 11 prior to the introduction of the oil into vat 18. The oil then passes through sealing portion 12, and spacer grid 17, and then exits vat 18 through pipe 22, after which the purified oil may be recycled to a fryer for further use.

As the oil passes through filter paper 11 and sealing portion 12 of vat 18, a vacuum is being applied to pipe 22 and vat 18. As the oil passes through filter paper 11 and sealing portion 12, and the vacuum is being applied, the peripheral edges of sealing portion 12, which are in contact with sides 15a, 15b, 15c, and 15d of weight ring 14, act as a gasket and forms a seal with the peripheral portion of the bottom panel 19 of vat 18. This seal enables improved purification and filtration of the used cooking oil as it passes through filter pad 11 and sealing portion 12. In addition, because the seal is formed by sealing portion 12 and not filter pad 11, the likelihood of breakage of filter pad 11 is reduced greatly.

FIG. 4 depicts additional non-limiting embodiments of the filter medium of the present invention, which have different stitching arrangements, whereby the sealing portion is affixed to the filter pad. Filter medium 110 includes filter pad 111, sealing portion 112, and stitch 113 running through peripheral portions of sealing portion 112 and the middle of filter pad 111 and the middle of sealing portion 112. Filter medium 210 includes filter pad 211, sealing portion 212, and stitches 213a, 213b, 213c, and 213d, which affix sealing portion 212 to filter pad 211 at the peripheral edges of filter pad 211. Filter medium 310 includes filter pad 311, sealing portion 312, and stitches 313a and 313b running through filter pad 311 and sealing portion 312. Stitches 313a and 313b are arranged in the form of a cross. Filter medium 410 includes filter pad 411, sealing portion 412, and stiches 413a, 413b, 413c, and 413d which run through the peripheral edges of filter pad 411 as well as through sealing portion 412.

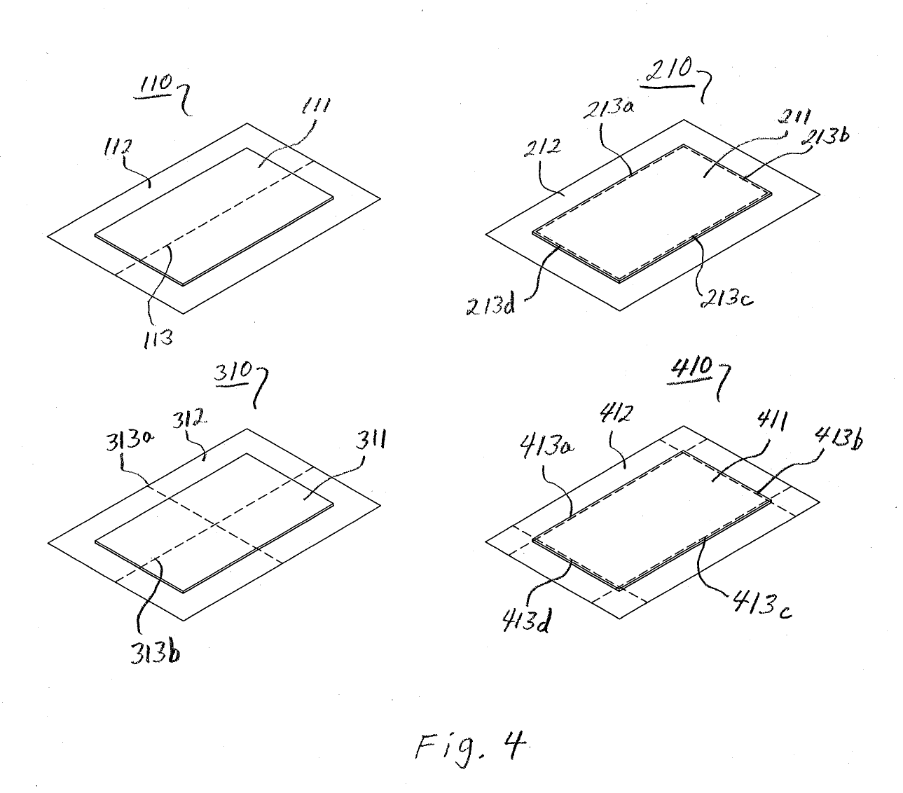

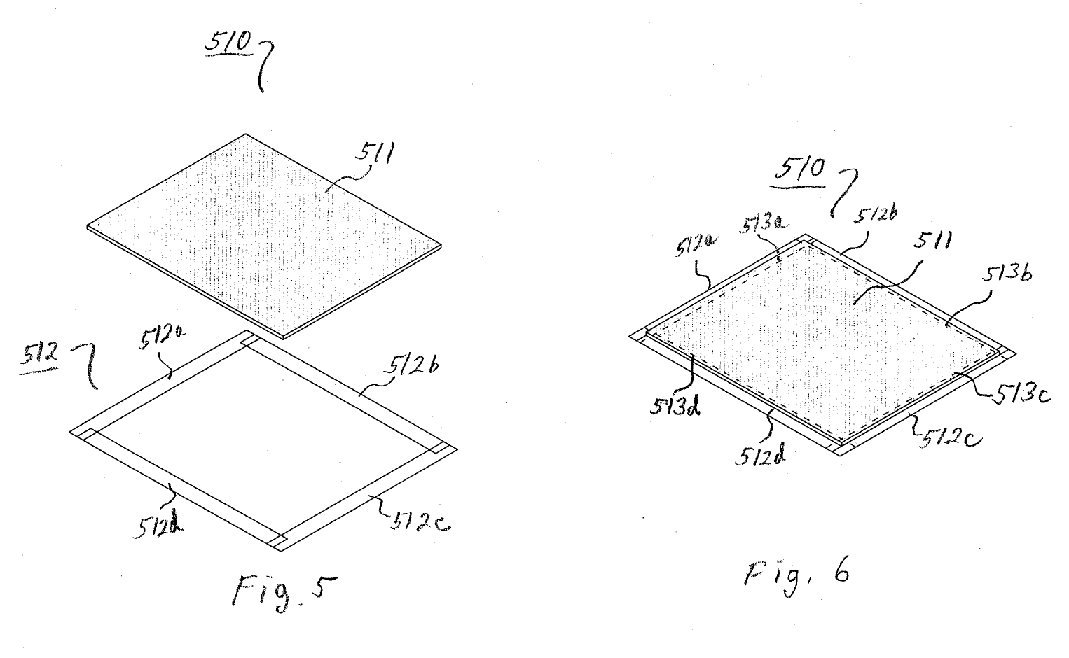

FIGS. 5 and 6 depict another non-limiting embodiment of a filter medium 510 of the present invention, which includes a filter pad 511, and a sealing portion 512 that is formed from four sealing strips 512a, 512b, 512c, and 512d. Sealing portion 512 is in the form of a “frame”, in which strips 512a, 512b, 512c, and 512d are in contact with filter pad 511 at only the four peripheral edges of filter pad 511. Sealing strip 512a is affixed to a peripheral edge of filter pad 511 by stitch 513a. Sealing strip 512b is affixed to a peripheral edge of filter pad 511 by stich 513b. Sealing strip 512c is affixed to a peripheral edge of filter pad 511 by stitch 513c. Sealing strip 512d is affixed to a peripheral edge of filter pad 511 by stich 513d.

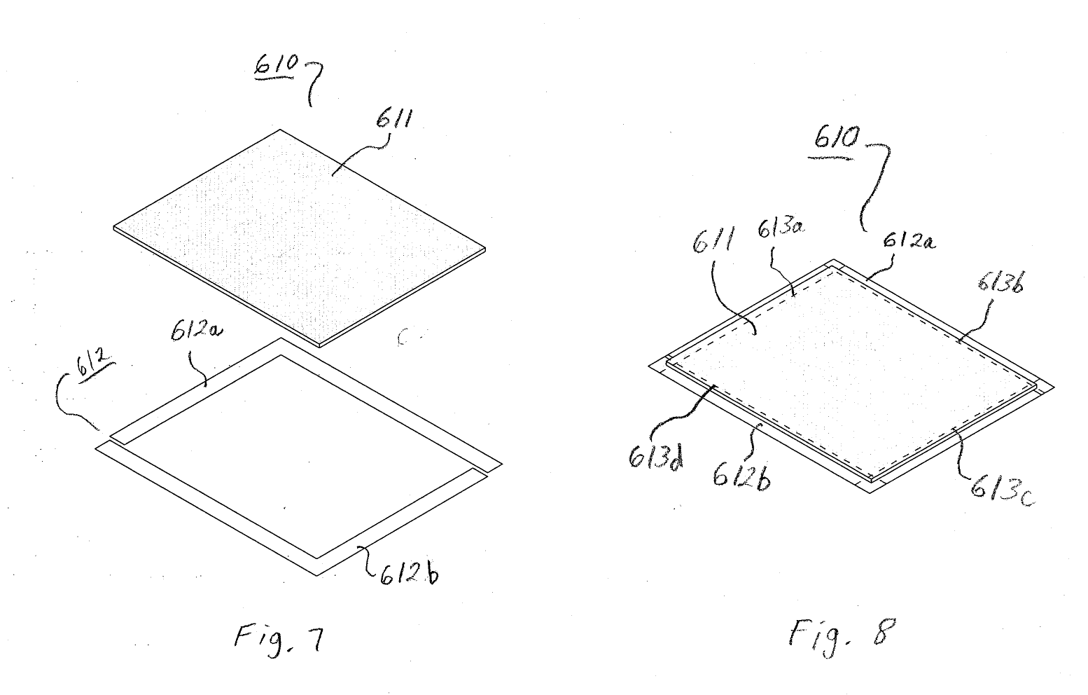

FIGS. 7 and 8 depict a further non-limiting embodiment of a filter medium 610 of the present invention, which includes a filter pad 611, and a sealing portion 612 that is formed from two L-shaped sealing means or sealing strips 612a and 612b. Sealing portion 612, like sealing portion 512 hereinabove described, also is in the form of a “frame”, in which L-shaped sealing strips are in contact with filter pad 611 at only the four peripheral edges of filter pad 611. Sealing strip 612a is affixed to two adjacent peripheral edges of filter pad 611 by stiches 613a and 613b. Sealing strip 612b is affixed to two adjacent peripheral edges of filter pad 611 by stiches 613c and 613d.

When filter media having a sealing portion in the form of a “frame”, such as filter media 510 and 610, are employed, the fluid, such as used cooking oil, for example, passes essentially only through the filter portion, such as filter pad 511 or 611, and at most, a minimal amount of the fluid passes through the sealing portion, such as sealing portion 512 or 612. When the sealing portion is impermeable, no fluid will pass through the sealing portion.

Although the filter medium of the present invention has been described in particularly with respect to the filtration and purification of used cooking oil, the filter medium of the present invention may be used to filter other fluids, such as unrefined edible oils in order to remove free fatty acids and other impurities, fruit-based and vegetable-based beverages, such as beer or wine, to remove chill haze components and other impurities, and biodiesel fuel, wherein soap, glycerides, and other impurities are removed.

The disclosures of all patents and publications are incorporated herein by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A filter medium for removing impurities from a fluid as said fluid passes through a container, said container comprising a bottom panel and at least one wall extending upwardly from said bottom panel, said filter medium comprising:
a filter portion, wherein said filter portion is capable of removing impurities from said fluid; and
a sealing portion, wherein said sealing portion extends outwardly from the filter portion and is affixed to said filter portion, wherein said sealing portion is capable of forming a seal with said bottom panel of said container when said filter medium is placed in said container.

2. The filter medium of claim 1 wherein said filter portion has a first permeability and said sealing portion has a second permeability, and wherein said first permeability is greater then said second permeability.

3. The filter medium of claim 1 wherein said filter portion has a first permeability and said sealing portion has a second permeability, and said first permeability and said second permeability are identical.

4. The filter medium of claim 1 wherein said filter portion has a first permeability and said sealing portion has a second permeability, and wherein said second permeability is greater than said first permeability.

5. The filter medium of claim 1 wherein said filter portion is impregnated with at least one adsorbent material.

6. The filter medium of claim 5 wherein said at least one adsorbent material is selected from the group consisting of magnesium silicate, magnesium aluminum silicate, calcium silicate, sodium silicates, activated carbon, silica gel, magnesium phosphate, metal hydroxides, metal oxides, metal carbonates, metal bicarbonates, sodium sesquicarbonate, metal silicates, bleaching clays, bleaching earths, bentonite clay, alumina, diatomaceous earth, perlite, and combinations thereof.

7. The filter medium of claim 6 wherein said at least one adsorbent material is magnesium silicate.

8. The filter medium of claim 1 wherein said sealing portion is affixed to said filter portion by stitching.

9. The filter medium of claim 1 wherein said sealing portion is affixed to said filter portion by an adhesive.

10. The filter medium of claim 1 wherein said filter portion is formed from materials including cellulosic fiber and resin binder.

11. The filter medium of claim 10 wherein said sealing portion is formed from materials including cellulosic fiber and resin binder.

12. The filter medium of claim 1 wherein said filter portion is formed from materials including cellulosic fiber and diatomaceous earth.

13. The filter medium of claim 1 wherein said filter portion is formed from materials including cellulosic fiber and perlite.

14. The filter medium of claim 1 wherein said sealing portion is in contact with the filter portion only at the peripheral edge or edges of the filter portion.

15. The filter medium of claim 14 wherein said sealing portion consists of four sealing strips, and wherein said filter portion is quadrilaterally-shaped and has four peripheral edges, and wherein each sealing strip is in contact with said filter portion at a peripheral edge of said filter portion.

16. The filter medium of claim 14 wherein said sealing portion consists of two L-shaped sealing strips, and wherein said filter portion is quadrilaterally-shaped and has four peripheral edges, and wherein each L-shaped sealing strip is in contact with two adjacent peripheral edges of said filter portion.

17. The filter medium of claim 14 wherein the permeability of said filter portion is greater than that of said sealing portion.

18. The filter medium of claim 17 wherein said sealing portion is impermeable.
